(19) United States
(12) Patent Application Publication
(10) Pub. No.: US 2009/0269652 A1
(43) Pub. Date: Oct. 29, 2009

(54) HOUSING FOR ACCOMMODATING AT LEAST A FUELL CELL STACK

(75) Inventor: Jens Hafemeister, Neustrelitz (DE)

Correspondence Address: DICKINSON WRIGHT PLLC, 1875 Eye Street, NW, Suite 1200, WASHINGTON, DC, 20006, US

(73) Assignee: ENERDAY GmbH, Stockdorf (DE)

(21) Appl. No.: 12/439,631

(22) PCT Filed: Jul. 5, 2007
(86) PCT No.: PCT/DE2007/001188

§ 371 Date: Mar. 2, 2009

(30) Foreign Application Priority Data
Sep. 7, 2006 (DE) 10 2006 042 109.4

(51) Int. Cl. H01M 2/08; H01M 2/02

(52) U.S. Cl. 429/35; 429/34

(57) ABSTRACT

The invention relates to an enclosure for accommodating at least one fuel cell stack (16; 116; 216; 316; 416), comprising a first enclosure shell (10; 110; 210; 310; 410) and a second enclosure shell (12; 112; 212; 312; 412), the first and second enclosure shells being compressed together by a clamping means so that the fuel cell stack to be accommodated can be compressed in its stacking direction by the flexibility of the clamping means.

The invention relates to a housing or enclosure for accommodating at least one fuel cell stack, comprising a first enclosure shell and a second enclosure shell.

The invention relates furthermore to a system comprising one such enclosure and a fuel cell stack.

Solid oxide fuel cell (SOFC) systems consist of a plurality of components involving, among other things, a reformer, an afterburner as well as a SOFC fuel cell stack. These components are operated at temperatures of around 900° C.

SOFC fuel cell stacks are known to be fabricated under a defined compression force. Compression of the stack is ensured during fabrication, storage and installation in the system by temporary clamping forces. Known for example from German patent DE 103 08 382 B3 is a possibility of bracing or compressing a fuel cell stack.

Existing possibilities of compression have, however, the disadvantage that should the high-temperature insulation shrink under pressure and high temperature, the compression fails to adequately accommodate this shrinkage, resulting in compression of the fuel cell stack not being assured lastingly.

Another disadvantage of the existing compression systems is that fitting the compression elements fails to be condusive to assembly.

It is thus the object of the present invention to create a possibility of lastingly ensure compression of at least one fuel cell stack condusive to assembly.

This object is achieved by the enclosure as set forth in claim 1.

Advantageous aspects and further embodiments of the invention read from the dependent claims.

To achieve the object the invention makes available an enclosure for accommodating at least one fuel cell stack. The enclosure comprises a first enclosure shell and a second enclosure shell, the first and second enclosure being compressed together by a clamping means so that the fuel cell stack to be accommodated can be compressed in its stacking direction by the flexibility of the clamping means. This enclosure has the advantage that at least the fuel cell stack is now always compressed optimally no matter which the operating condition and temperature. Furthermore, this creates an enclosure which combines the accommodating function and compression function whilst still be very simple and uncomplicated to fit in thus not only reducing the complications and costs of fitting but also the production costs. Furthermore, accessability for maintenance is now improved, i.e. without necessitating complicated disassembly. Yet another advantage is the protection of the accommodated elements from dirt and damage.

Furthermore, the enclosure may be configured such that the enclosure shells can be moved away from each other in the stacking direction of the fuel cell stack by a certain distance without creating a gap. This has the advantage that even when the fuel cell stack expands because of the increase in temperature, the stack is now always located in a space closed off from the environment in thus protecting the inner space from dirt and damage.

This motion free of generating a gap is achievable in that a flexible seal is disposed between the facing edges of the enclosure shells. Now, when the enclosure shells are moved away from each other such a preferably highly flexible seal can fill out the additional space due to the reduced compression in thus preventing a gap materializing between the enclosure shells.

As an alternative, or in addition thereto, achieving this motion without generating a gap is also possible in that the enclosure shells are nestable with the advantage that the enclosure shells support and stabilize each other in a direction perpendicular to the stacking direction of the fuel cell stack to thus achieve a very rugged and simply configured compression arrangement. Another advantage is that heat radiated from the elements accommodated by the enclosure to the exterior can now be strongly reduced since the elements in the interior are always walled in no matter what the operating condition.

The enclosure in accordance with the invention can be further sophisticated to advantage in that the clamping means comprises a plurality of hinged spring clamps. Making use of hinged spring clamps now makes it possible to do away with tools for fitting and securing the enclosure shells, making for very simple and cost-effective means of assuring optimum compression of the fuel cell stack.

As an alternative, it may be provided for that the clamping means is a clamping frame with springs, a clamping frame makes it possible to achieve rugged high force compression.

In addition, the enclosure in accordance with the invention may be sophisticated so that the enclosure shells are made of an insulating material. In addition to the accommodating and compression function this further embodiment offers the advantage that the enclosure also provides an insulating function.

As an alternative, this advantage can also be achieved by coating the enclosure shells with a layer of insulating material.

Furthermore, the enclosure in accordance with the invention may be sophisticated in that the inner enclosure shell nestable in the outer enclosure shell extends so far in the stacking direction of fuel cell stack that at least 90% of the stacking height of the fuel cell stack to be accommodated is accommodated by the inner enclosure shell. This variant offers the advantage that almost the complete fuel cell stack is supported in one direction perpendicular to the stacking direction, i.e. eliminating complicated fasteners for the individual fuel cell elements of the fuel cell stack.

In addition the enclosure in accordance with the invention can be sophisticated in that the enclosure is designed to house a reformer and/or an afterburner of the fuel cell system at least in part. This now makes it possible to accommodate a complete fuel cell system in the enclosure, this too with the advantage that a very simple and cost-effective means of assembly is now achievable.

This embodiment may be sophisticated to advantage in that both enclosure shells for accommodating the reformer and/or the afterburner feature recesses each open to the open end of the enclosure shells. This again ensures simple assembly whilst making it possible to guide a tubular reformer and/or afterburner through the two ends of the enclosure. In addition to facilitating assembly these recesses also offer the advantage of compressing these elements through the walls of the enclosure.

The present invention furthermore provides a system comprising one such enclosure and a fuel cell stack, this system offering the advantages as recited above correspondingly.

The invention will now be detailed by way of a particularly preferred embodiment with reference to the attached drawings in which:

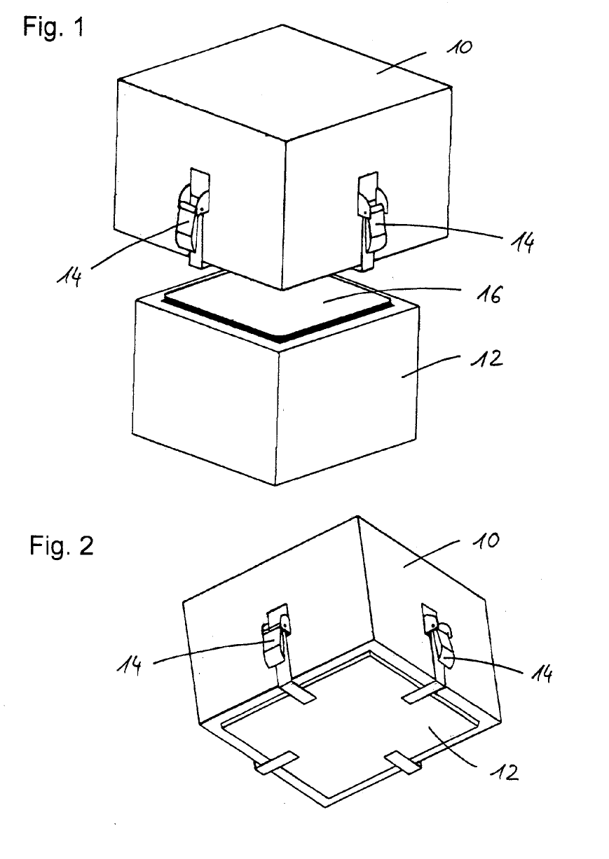

FIG. 1 is a diagrammatic representation of an enclosure in accordance with the invention in a first exemplary embodiment shown open;

FIG. 2 is an illustration of the enclosure in accordance with the invention as shown in FIG. 1 but shown closed;

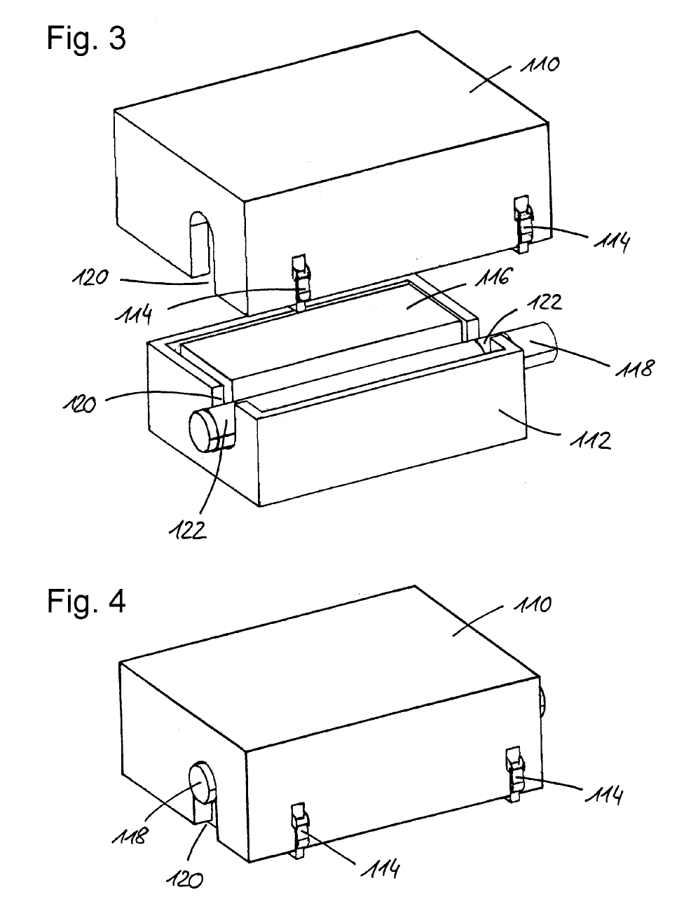

FIG. 3 is a diagrammatic representation of the enclosure in accordance with the invention in a second exemplary embodiment shown open;

FIG. 4 is an illustration of the enclosure as shown in FIG. 3 but shown closed;

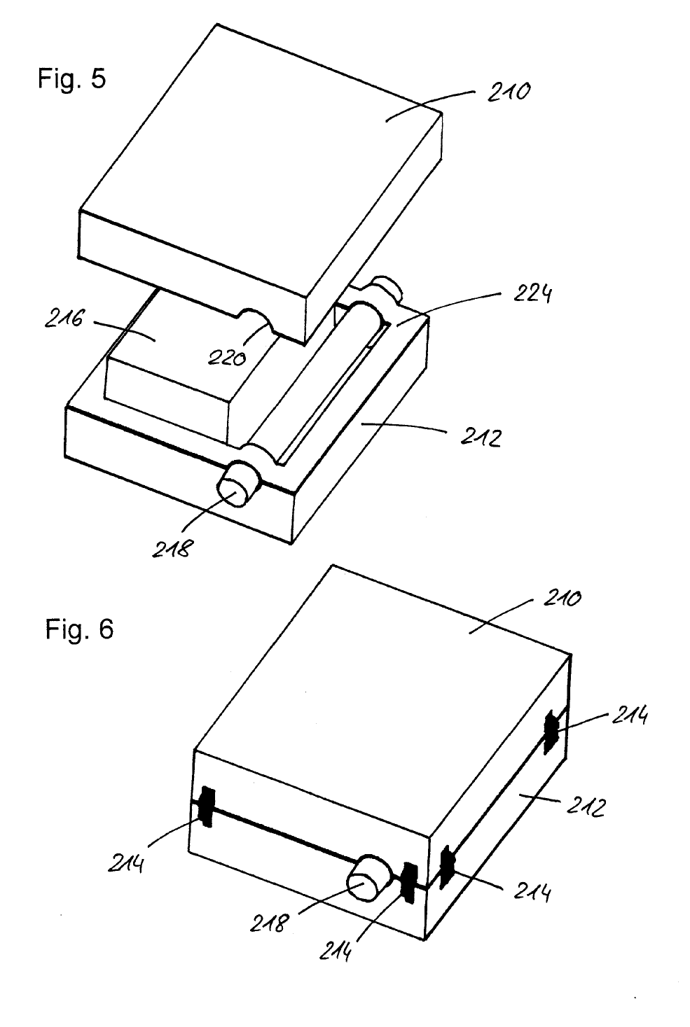

FIG. 5 is a diagrammatic representation of the enclosure in accordance with the invention in a third exemplary embodiment shown open;

FIG. 6 is an illustration of the enclosure as shown in FIG. 5 but shown closed;

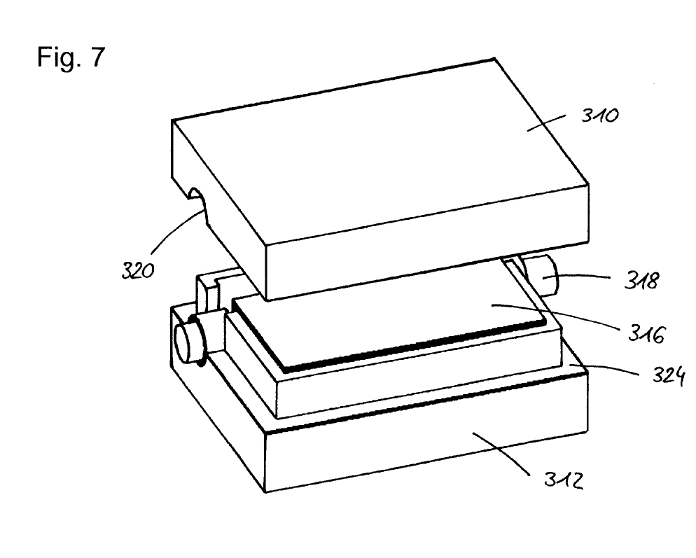

FIG. 7 is a diagrammatic representation of the enclosure in accordance with the invention in a fourth exemplary embodiment shown open;

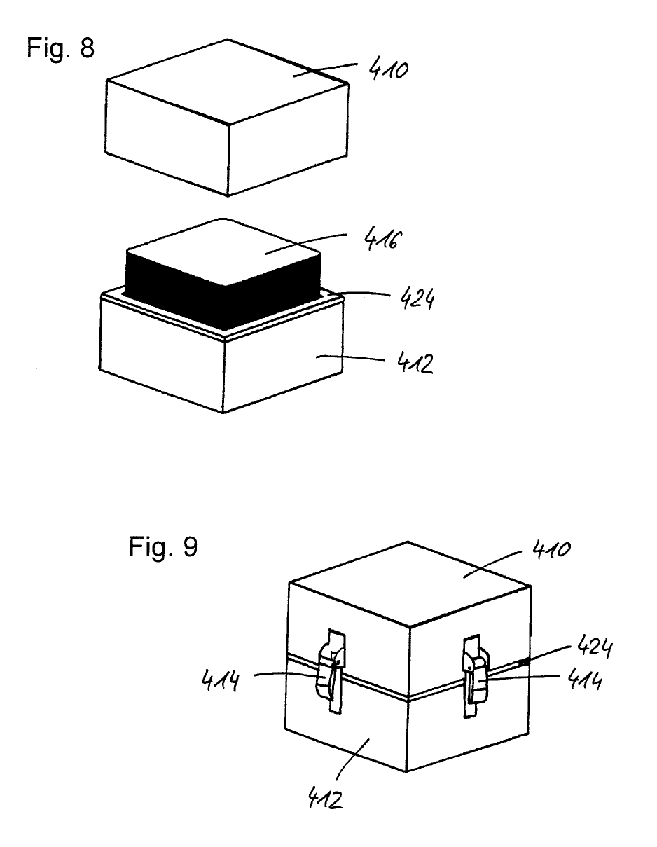

FIG. 8 is a diagrammatic representation of the enclosure in accordance with the invention in a fifth exemplary embodiment shown open; and

FIG. 9 is an illustration of the enclosure as shown in FIG. 8 but shown closed.

Referring now to FIGS. 1 and 2 there is illustrated a first exemplary embodiment of the enclosure in accordance with the invention, FIG. 1 showing the enclosure open, FIG. 2 the enclosure closed. The enclosure in accordance with the invention comprises an outer enclosure shell 10 and an inner enclosure shell 12 preferably made of an insulating material. As an alternative, the outer enclosure shell 10 and/or inner enclosure shell 12 may be lined and/or coated on the outer side with an insulating material. The two enclosure shells 10, 12 are parallelepipedal shells open at the one end, dimensioned to nest dead true or with a small clearance. The outer enclosure shell 10 is provided with a four hinged spring clamps 14. The hinged spring clamps 14 are fixedly attached to the outer side of the outer enclosure shell 10 so that the grips of the hinged spring clamps 14 partly clasp the inner enclosure shell 12, i.e. the grips urge the outer bottom side of the inner enclosure shell 12 into the outer enclosure shell 10 with a certain flexibility so that the inner enclosure shell 12 is held in the outer enclosure shell 10. As an alternative to the hinged spring clamps 14 a clamping frame may serve to clamp the shells together as is disclosed in German patent DE 103 08 382 B3. The enclosure is designed to accommodate at least one fuel cell stack 16. The fuel cell stack 16 is inserted into the inner enclosure shell 12 so that the walls of the inner enclosure shell 12 support the fuel cell stack 16 in a direction perpendicular to the stacking direction of the fuel cell stack 16 (the stacking direction of the fuel cell stack corresponding to the vertical direction as shown in FIG. 1). The inner enclosure shell 12 is dimensioned so that the fuel cell stack 16 is accommodated near totally by the inner enclosure shell 12, more than 90% of the fuel cell stack being housed therein preferably. Since the fuel cell stack 16 juts up from the inner enclosure shell 12 the fuel cell stack 16 is compressed stacked when the enclosure is closed by the hinged spring clamps 14 down, i.e. the bottoms of the two enclosure shells 10, 12 are urged together by the hinged spring clamps 14 that the fuel cell stack 16 is compressed between the bottoms in the stacking direction. It is in this way that the clamping effect is maintained by the flexibility of the hinged spring clamps 14 and the shiftability of the enclosure shells 10, 12 in any operating condition. For the feeders to the fuel cell stack 16 ports (not shown) may be provided in the bottom of the inner enclosure shell 12.

Referring now to FIGS. 3 and 4 there is illustrated a second exemplary embodiment of the enclosure in accordance with the invention, FIG. 3 showing the enclosure open, FIG. 4 closed. The enclosure in accordance with the second exemplary embodiment comprises an outer enclosure shell 110 and an inner enclosure shell 112, the outer enclosure shell being provided with hinged spring clamps 114. To avoid tedious repetition it is to be explicitly appreciated that the outer enclosure shell 110 and recess 120 differ from the outer enclosure shell 10 and inner enclosure shell 12 respectively of the first exemplary embodiment merely by the aspects as described in the following. The hinged spring clamps 14 are identical to the hinged spring clamps 114 (a clamping frame as cited in the first exemplary embodiment possible being provided as an alternative). Unlike the first exemplary embodiment the enclosure in the second exemplary embodiment not only houses a fuel cell stack 116 but the complete fuel cell system. Shown in FIG. 3 as part of the fuel cell system is a burner tube 118 which may be a reformer or an afterburner or a part thereof. To house this burner tube 118 the outer enclosure shell 110 and inner enclosure shell 112 are each provided with a recess 120 open to the side opposite the corresponding bottom of the enclosure shells 110, 112 concerned. The radius of the closed end of each recess 120 substantially corresponds to half the diameter of the burner tube 118. The width of the recesses 120 substantially corresponds to the diameter of the burner tube 118. To improve insulation and to compensate for production tolerances to thus make for better compression the burner tube 118 may be provided with a sheath 122 of an insulating or damping material. As regards how the compression functions, reference is made to the previous exemplary embodiment.

Referring now to FIGS. 5 and 6 there is illustrated a third exemplary embodiment of the enclosure in accordance with the invention, FIG. 5 showing the enclosure open, FIG. 6 the enclosure closed. The enclosure in accordance with the third exemplary embodiment comprises an upper enclosure shell 210 and a lower enclosure shell 212. The enclosure shells 210, 212 are preferably made of an insulating material. As an alternative, the upper and/or lower enclosure shell can be lined and/or coated on the outer side with an insulating material. The two enclosure shells are parallelepipedal shells open at the one end, the edges at each open end of which trap a resilient seal 224. The same as in the second exemplary embodiment the enclosure accommodates not just a fuel cell stack 216 but the complete fuel cell system. Shown as part of the fuel cell system in FIGS. 5 and 6 is a burner tube 218 which may be a reformer or an afterburner or a part thereof. To house this burner tube 218 the upper enclosure shell 210 and lower enclosure shell 212 are each provided with recesses 220 open to the end opposite the corresponding bottom of the enclosure shell 210, 212 concerned. In this arrangement, the four recesses 220 for the burner tube 218 each correspond to a semi-circle, the radius of which is somewhat larger than half the outer diameter of the burner tube 218. The reason for the radius being somewhat larger is because disposed between the inserted burner tube 218 and the enclosure shells 210 and 212 is the seal 224 which as evident from the top-down view (FIG. 5) is preferably framelike in structure. At the portions of the recesses 220 the seal 224 is formed ring-shaped to surround the burner tube 218. These ring-shaped portions of the seal 224 are preferably connected integrally to the remaining flat portions. Furthermore, the upper enclosure shell 210 features eight hinged spring clamps 214 functioning as a clamping means (four of the hinged spring clamps 214 are evident from FIG. 6; FIG. 5 showing no hinged spring clamps 214 so as not to clutter up the illustration). Two each of the hinged spring clamps 214 are attached to a side surface of the enclosure shell 210. The grips of the hinged spring clamps 214 in this exemplary embodiment engage notches or slots provided correspondingly positioned in the lower enclosure shell 212 down to which the grips of the hinged spring clamps 214 extend. As an alternative to the notches or slots corresponding protuberances or pins may be provided. Via the hinged spring clamps 214 the upper and lower enclosure shells 210, 212 can be compressed with a certain flexibility. When the enclosure is closed, the fuel cell stack 216 is accommodated therein such that it is compressed between the bottoms of the two enclosure shells 210, 212. To begin with, in this arrangement, the seal 224 is strongly compressed. Due to the hinged spring clamps 214 the fuel cell stack 216 is compressed in its stacking direction between these bottoms that the compression is maintained by the flexibility of the hinged spring clamps 214 in any operating condition. For the feeders to the fuel cell stack 216 ports (not shown) may be provided in the bottom of the lower enclosure shell 212. As an alternative to the hinged spring clamps 214 the aforementioned compression frame may be provided. When the system as described above is operated, the fuel cell stack 216 expands because of the heat. The enclosure shells 210 and 212 may be minimally parted, but this motion is complied with by the seal 224, i.e. in reducing the compression of the seal 224, resulting in it taking up more space in thus preventing an open gap materializing between the enclosure shells 210 and 212. Due to the force of the hinged spring clamps 214, on the one hand, and the force of expansion, on the other, as well as due to the heat the material of the enclosure shells 210, 212 may lastingly shrink. But the flexibility of the hinged spring clamps 214 and the flexibility of the seal 224 offset these movements no matter what the operating condition, resulting in the fuel cell stack always being optimally compressed in always preventing a gap materializing between the enclosure shells 210, 212.

Referring now to FIG. 7 there is illustrated a diagrammatic representation of the enclosure in accordance with the invention in a fourth exemplary embodiment shown open. This enclosure comprises an upper enclosure shell 310 and a lower enclosure shell 312. To avoid tedious repetition the following description of the fourth exemplary embodiment discusses only the differences as compared to the third exemplary embodiment. In the fourth exemplary embodiment the lower enclosure shell 312 features a ledge corresponding to the upper edge of the lower enclosure shell 212 of the third exemplary embodiment. Seated on the ledge is thus a highly flexible seal 324 on which, in turn the edge of the open end of the upper enclosure shell 310 rests. Above the ledge the wall of the lower enclosure shell 312 is thinner than below the ledge. Above the ledge the outer side of the lower enclosure shell 312 is slidingly located dead true to the inner side of the upper enclosure shell 310 or with a slight clearance. Accordingly, this exemplary embodiment combines the sliding location in the two enclosure shells in accordance with the first and second exemplary embodiment with the insertion of a flexible seal in accordance with the third exemplary embodiment. In addition to the function of the third exemplary embodiment, the fourth exemplary embodiment provides for the fuel cell stack 316 being accommodated by the lower enclosure shell 312 practically completely. Preferably more than 90% of the fuel cell stack is accommodated in the lower enclosure shell 312, resulting in the fuel cell stack being supported also in the direction perpendicular to the stacking direction. As regards the remaining components (e.g. comprising hinged spring clamps or a clamping frame) and function, reference is made the third exemplary embodiment.

Referring now to FIGS. 8 and 9 there is illustrated a fifth exemplary embodiment of the enclosure in accordance with the invention, FIG. 8 showing the enclosure open, FIG. 9 the enclosure closed. This exemplary embodiment differs from the third exemplary embodiment in that just one fuel cell stack 416 is accommodated and compressed by the upper enclosure shell 410 and lower enclosure shell 412. Accordingly, no recesses are provided for a burner tube or the like. Furthermore no flexible seal 424 with ring-shaped portions is provided, it instead being configured as a frame (shown top-down in FIG. 8) of consistent thickness. The hinged spring clamp 414 including the assigned means of engagement are the same as those of the third exemplary embodiment, whereby as already repeatedly mentioned, as an alternative, the clamping frame may be provided.

As a modification it may also be provided for in the third, fourth and fifth exemplary embodiment that the sealing surfaces of the enclosure shells, i.e. the facing surfaces thereof are engineered toothed, the toothing of the one enclosure shell meshing with the toothing of the other enclosure shell. The flexible seal interposed is preferably configured so that it complies to the toothing. The advantage of such an embodiment is that the toothing helps in reducing the heat irradiated, due to each tooth holding back the heat in the interior of the enclosure better than when the sealing surfaces are flat.

It is understood that the features of the invention as disclosed in the above description, in the drawings and as claimed may be essential to achieving the invention both by themselves or in any combination.

### LIST OF REFERENCE NUMERALS

10 outer enclosure shell
12 inner enclosure shell
14 hinged spring clamp
16 fuel cell stack
110 outer enclosure shell
112 inner enclosure shell
114 hinged spring clamp
116 fuel cell stack
118 burner tube
120 recesses
122 sheath
210 upper enclosure shell
212 lower enclosure shell
214 hinged spring clamp
216 fuel cell stack
218 burner tube
220 recesses
224 seal
310 upper enclosure shell
312 lower enclosure shell
316 fuel cell stack
318 burner tube
320 recesses
324 seal
410 upper enclosure shell
412 lower enclosure shell
414 hinged spring clamp
416 fuel cell stack
424 seal

1. An enclosure for accommodating at least one fuel cell stack, comprising a first enclosure shell and a second enclosure shell the first and second enclosure being compressed together by a clamping means so that the fuel cell stack to be accommodated can be compressed in its stacking direction by the flexibility of the clamping means.

2. The enclosure of claim 1, wherein the enclosure shells can be moved away from each other in the stacking direction of the fuel cell stack by a certain distance without creating a gap.

3. The enclosure of claim 1, further comprising a flexible seal is disposed between the facing edges of the enclosure shells.

4. The enclosure of claim 1, wherein the enclosure shells are nestable.

5. The enclosure of claim 1, wherein the clamping means comprises a plurality of hinged spring clamps.

6. The enclosure of claim 1, wherein the clamping means is a clamping frame with springs.

7. The enclosure of claim 1, wherein the enclosure shells are made of an insulating material.

8. The enclosure of claim 1, wherein the enclosure shells are provided with a layer of insulating material.

9. The enclosure of claim 4, wherein the inner enclosure shell nestable in the outer enclosure shell extends so far in the stacking direction of fuel cell stack that at least 90% of the stacking height of the fuel cell stack to be housed is accommodated by the inner enclosure shell.

10. The enclosure of claim 1, wherein the enclosure is designed to house a reformer and/or an afterburner of the fuel cell system at least in part.

11. The enclosure as set forth in of claim 10, wherein both enclosure shells for accommodating the reformer and/or the afterburner feature recesses each open to the open end of the enclosure shells.

12. A system comprising an enclosure of claim 1, wherein and a fuel cell stack.
